(19) United States
(12) Patent Application Publication
(10) Pub. No.: US 2026/0266289 A1
(43) Pub. Date: Sep. 10, 2026

(54) ELECTRIC COMPRESSOR

(71) Applicant: Hanon Systems, Daejeon (KR)

(72) Inventors: Kweon Soo Lim, Daejeon (KR); In Cheol Shin, Daejeon (KR)

(21) Appl. No.: 18/876,401

(22) PCT Filed: Nov. 8, 2023
(86) PCT No.: PCT/KR2023/017804

§ 371 Date: Dec. 18, 2024

(30) Foreign Application Priority Data
Jan. 5, 2023 (KR) 10-2023-0001792

(51) Int. Cl. F04C 18/02

(52) U.S. Cl. CPC F04C 18/0215; F04C 2240/30

(57) ABSTRACT

An electric compressor including a casing, a drive part disposed in the casing, a compression mechanism including an orbiting scroll, and a fixed scroll configured to engage with the orbiting scroll and compress a refrigerant, a rotary shaft configured to rotate, a guide pin disposed on a surface of the center head that faces the orbiting scroll, the guide pin having an end protruding toward the orbiting scroll, a guide groove recessed inward in a surface of the orbiting scroll that faces the center head, a sleeve ring disposed at an inner periphery of the guide groove and having an open ring hole into which an end of the guide pin is inserted, and an elastic member disposed in the sleeve ring and configured to simultaneously come into contact with the end of the guide pin and the guide groove.

### CROSS REFERENCE TO RELATED PATENT APPLICATIONS

This is a U.S. national phase patent application of PCT/KR2023/017804 filed Nov. 8, 2023, which claims the benefit of and priority to Korean Patent Application No. 10 2023 0001792 filed on Jan. 5, 2023, the entire contents of each of which are incorporated herein by reference for all purposes.

### TECHNICAL FIELD

The present invention relates to an electric compressor, and more particularly, to an electric compressor capable of mitigating a degree to which an orbiting scroll is tilted or slanted during an operation, thereby preventing a deterioration in compression performance and suppressing the occurrence of impact and noise.

### BACKGROUND ART

In general, an air conditioning (A/C) device is installed in a vehicle to cool or heat the interior of the vehicle. The air conditioning device includes a compressor which is a component of a cooling system, and the compressor compresses a low-temperature and low-pressure gaseous refrigerant introduced from an evaporator to make a high-temperature and high-pressure gaseous refrigerant and delivers the refrigerant to a condenser.

The compressors are classified into a reciprocating compressor which compresses a refrigerant using a reciprocating motion of a piston, and a rotary compressor which compresses a refrigerant using a rotational motion. Depending on methods of transmitting driving power, the reciprocating compressors are classified into a crank compressor which transmits power to a plurality of pistons using a crank, and a swash plate compressor which transmits power to a rotary shaft on which a swash plate is installed. The rotary compressors are classified into a vane rotary compressor which uses a rotating rotary shape and vanes, and a scroll compressor which uses an orbiting scroll and a fixed scroll.

The scroll compressor has an advantage in that the scroll compressor may obtain a relatively higher compression ratio than other compressors, smoothly perform processes of introducing, compressing, and discharging the refrigerant, and thus obtain stable torque.

Therefore, the scroll compressor is widely used to compress the refrigerant in an air conditioning device or the like.

The scroll compressor may be implemented as an electric scroll compressor. In this case, the electric scroll compressor may belong to the classification of the scroll compressors.

The scroll compressor compresses a refrigerant by means of an interaction between the orbiting scroll and the fixed scroll. In this case, the orbiting scroll is connected to an eccentric bushing disposed at an end of a driving shaft connected to a motor and defines a compression region together with the fixed scroll by using a rotational force transmitted to the eccentric bushing by a rotation of the driving shaft. Further, the compressed refrigerant is discharged through a discharge port formed in the fixed scroll.

Recently, electric compressors have been increasingly adopted with the increasing proliferation of electric vehicles powered by secondary batteries.

FIGS. 1A and 1B illustrate a structure between a center head 11 and an orbiting scroll 16 of an electric compressor 10 in the related art.

With reference to FIG. 1A, a pin 12 is mounted in the center head 11, and a groove 16a is formed in the orbiting scroll 16. A ring 13 is disposed on an inner peripheral surface of the groove 16a. In this case, the pin 12 is disposed and inserted into a ring hole 13a formed in a central portion of the ring 13.

In this case, the pin 12 and the ring 13 are configured to prevent a rotation of the orbiting scroll 16. When the orbiting scroll 16 engages with a fixed scroll 14 and rotates, the pin 12 restricts an orbiting range of the ring 13, thereby preventing the rotation of the orbiting scroll 164 while restricting the orbiting range of the orbiting scroll 164 to which the ring 13 is connected.

In this case, an end of the pin 12 defines a predetermined gap together with a bottom surface of the groove 16a. This is to prevent the occurrence of friction between the end of the pin 12 and the bottom surface of the groove 16a when the orbiting scroll 16 vibrates in an axial direction.

Meanwhile, with reference to FIG. 1B, there may occur a problem in that the orbiting scroll 16 slanted or warped during the operation of the electric compressor 10. This problem occurs when a load greatly changes during the process in which the electric compressor 10 operates. That is, a load for compressing the refrigerant may be greatly changed when the electric compressor 10 initially operates (on) or stops operating (off) or during other operations.

When the orbiting scroll 16 is slanted or warped, there may occur a problem in that wraps 14b of the fixed scroll 14 and wraps 16b of the orbiting scroll 16 collide with one another, and the pin 12 and the ring 13 collide with each other.

Further, with reference to FIG. 1C, a drive bearing 17 configured to support a rotation of the orbiting scroll 16 cannot properly support the orbiting scroll 16, which may degrade durability and cause noise.

In this case, an outer race of the drive bearing 17 supports the orbiting scroll 16, and an inner race of the drive bearing 17 supports a rotary shaft 19. In this case, when there occurs a problem in that the orbiting scroll 16 is slanted, the outer race and the inner race are warped, and a force indicated by the arrow is consistently applied to a cage 17b that supports balls 17a of the drive bearing 17.

That is, the orbiting scroll 16, which is warped and vibrated, consistently applies a force to the cage 17b and damages the cage 17b.

This degrades the lifespan of the drive bearing 17 and causes noise.

In addition, when the orbiting scroll 16 is slanted or warped, the wrap 16b of the orbiting scroll 16 and the wrap 14b of the fixed scroll 14 cannot be completely tightly attached to each other, a compression leak of the refrigerant occurs from a compression chamber. This degrades the performance of the electric compressor.

### SUMMARY

The present invention has been made in an effort to solve the above-mentioned problem in the related art, and an object of the present invention is to provide an electric compressor capable of mitigating a degree to which an orbiting scroll is tilted or slanted, thereby preventing a deterioration in compression performance and suppressing the occurrence of impact and noise.

In order to achieve the above-mentioned object, the present invention provides an electric compressor including: a casing; a drive part disposed in the casing and configured to generate power; a compression mechanism including an orbiting scroll, and a fixed scroll configured to engage with the orbiting scroll and compress a refrigerant; a rotary shaft configured to rotate to receive power from the drive part and transmit the power to the compression mechanism; a center head disposed between the drive part and the compression mechanism and configured to support the rotary shaft; a guide pin disposed on a surface of the center head that faces the orbiting scroll, the guide pin having an end protruding toward the orbiting scroll; a guide groove recessed inward in a surface of the orbiting scroll that faces the center head; a sleeve ring disposed at an inner periphery of the guide groove and having an open ring hole into which an end of the guide pin is inserted; and an elastic member disposed in the sleeve ring and configured to simultaneously come into contact with the end of the guide pin and the guide groove.

In addition, in the embodiment of the present invention, the guide groove may have a dual stepped structure, and the guide groove may include: a ring insertion groove disposed in a surface of the orbiting scroll facing the center head so that the sleeve ring is inserted into the ring insertion groove; and a stepped groove connected to the ring insertion groove and configured to define a step difference together with the ring insertion groove, the elastic member being disposed in the stepped groove.

In addition, in the embodiment of the present invention, a periphery of the elastic member may be supported by the stepped groove.

In addition, in the embodiment of the present invention, a size of an outer periphery of the elastic member may be equal to or larger than a size of an inner periphery of the stepped groove.

In addition, in the embodiment of the present invention, the elastic member may be inserted into the stepped groove and then expand without being withdrawn from the stepped groove.

In addition, in the embodiment of the present invention, the elastic member may be temporarily in contact with, instead of being always in contact with, the end of the guide pin and a bottom surface of the stepped groove during an operation of the compression mechanism.

In addition, in the embodiment of the present invention, the contact between the end of the guide pin and the elastic member may be surface contact.

In addition, in the embodiment of the present invention, the elastic member may include: a body portion formed in a shape corresponding to the ring hole; a contact portion formed on a surface of the body portion that faces the guide pin; a support portion formed to protruding from a surface of the body portion that faces a bottom surface of the stepped groove; and an opening portion formed inside the support portion in the body portion.

In addition, in the embodiment of the present invention, the contact portion may have a flat plate shape.

In addition, in the embodiment of the present invention, the elastic member may further include a stretchable/contractible portion having a bent shape disposed between the body portion and the support portion.

In addition, in the embodiment of the present invention, the elastic member may include: a plurality of protrusion portions formed to protrude from the surface of the body portion that faces the bottom surface of the stepped groove; and a plurality of open grooves concavely formed between the plurality of protrusion portions in the body portion.

According to the present invention, it is possible to mitigate a degree to which the orbiting scroll is tilted, slanted, or warped during the operation.

In addition, the orbiting scroll and the fixed scroll may properly engage with each other, which may prevent a deterioration in compression performance.

In addition, it is possible to reduce the occurrence of noise by mitigating impact between the wrap of orbiting scroll and the wrap of the fixed scroll.

This may ultimately improve the performance and quality of the electric compressor.

### DESCRIPTION OF DRAWINGS

FIG. 1A is a partial cross-sectional view illustrating an arrangement structure between a pin, a groove of an orbiting scroll, and a ring of an electric compressor in the related art.

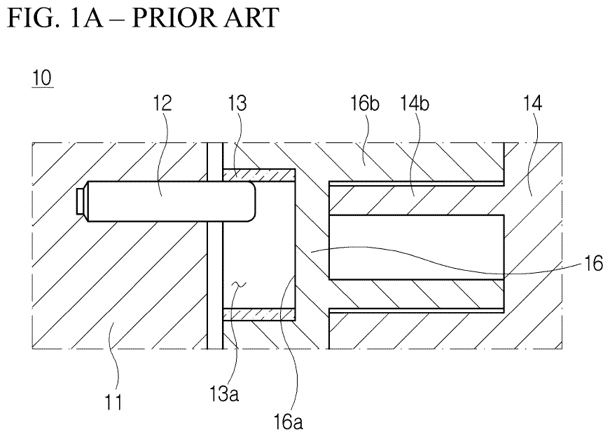

FIG. 1B is a partial cross-sectional view illustrating a state in which the orbiting scroll of the electric compressor in the related art tilted or slanted, and a wrap of the orbiting scroll and a wrap of a fixed scroll collide with each other.

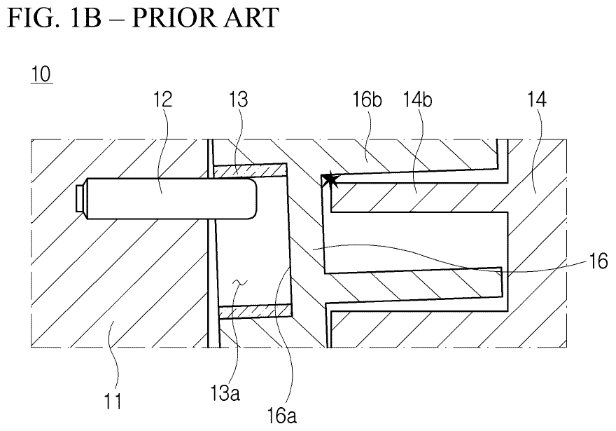

FIG. 1C is a partial cross-sectional view illustrating a state in which a load is applied to a bearing as the orbiting scroll in the related art is tilted or slanted.

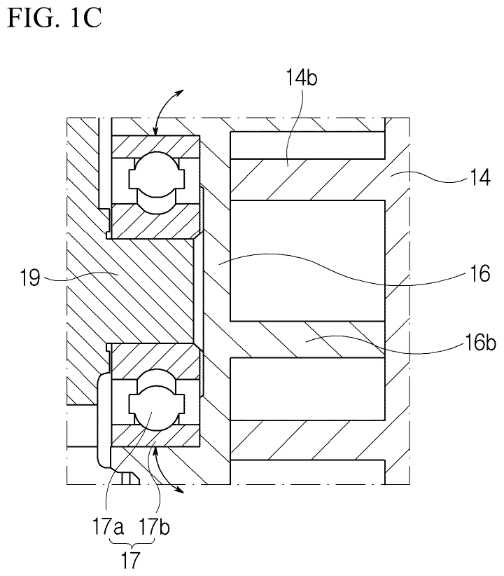

FIG. 2 is a cross-sectional view illustrating a structure of an electric compressor according to an embodiment of the present invention.

FIG. 3A is a partial cross-sectional view illustrating a first embodiment of an elastic member according to an embodiment of the present invention.

FIG. 3B is a partial cross-sectional view illustrating a state in which the elastic member of the first embodiment is in contact with a guide pin when an orbiting scroll is tilted or slanted.

FIG. 4 is a partial cross-sectional view illustrating a second embodiment of the elastic member of the present invention.

FIG. 5 is a partial cross-sectional view illustrating a third embodiment of the elastic member of the present invention.

### DESCRIPTION OF AN EMBODIMENT

Advantages and features of the present invention and methods of achieving the advantages and features will be clear with reference to embodiments described in detail below together with the accompanying drawings. However, the present invention is not limited to the embodiments disclosed herein but will be implemented in various forms. The embodiments of the present invention are provided so that the present invention is completely disclosed, and a person with ordinary skill in the art to which the present invention pertains can fully understand the scope of the present invention. The present invention will be defined only by the scope of the appended claims.

Shapes, sizes, ratios, angles, numbers, and the like illustrated in the drawings for explaining the embodiments of the present invention are just exemplarily illustrated, and the present invention is not limited to the contents illustrated in the drawings. Throughout the specification, the same reference numerals denote the same constituent elements. In addition, in the description of the present invention, the specific descriptions of publicly known related technologies will be omitted when it is determined that the specific descriptions may unnecessarily obscure the subject matter of the present invention. The terms “comprise,” “have,” or “include” used in the present specification may mean that other constituent elements can be added unless these terms are used with the term “only”. Unless otherwise particularly and clearly stated, the singular expressions used herein are intended to include the plural expressions.

Unless otherwise separately and explicitly stated, analyses of constituent elements are interpreted as including error ranges.

In the description of a positional relationship, for example, when a positional relationship between two components is described by using terms ‘on,’ ‘above,’ ‘below,’ ‘at a lateral side of,’ and the like, one or more components may be positioned between the two components when term ‘immediately,’ or ‘directly’ is not used.

Terms “first”, “second”, and the like may be used to describe various constituent elements, but the constituent elements are not limited by these terms. These terms are merely used to distinguish one constituent element from another constituent element. Therefore, the first constituent element mentioned hereinafter may be the second constituent element within the technical spirit of the present invention.

Throughout the specification, the same reference numerals denote the same constituent elements.

The size and thickness of each component illustrated in the drawings are shown for ease of description, but the present invention is not necessarily limited to the size and thickness of the illustrated component.

Respective features of several embodiments of the present invention may be partially or entirely coupled to or combined with each other, and as sufficiently appreciated by those skilled in the art, various technical cooperation and operations may be made, and the respective embodiments may be carried out independently of each other or carried out together correlatively.

Hereinafter, exemplary embodiments according to the present invention will be described in detail with reference to the accompanying drawings. The plurality of embodiments described below may be applied in duplicate as long as the embodiments do not conflict with one another.

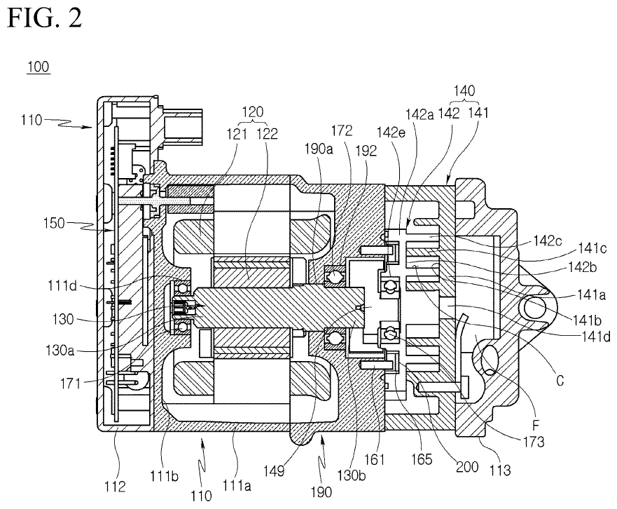

First, a structure of an electric compressor or a scroll compressor to which the present invention is applied will be described with reference to FIG. 2.

With reference to FIG. 2, the electric compressor or the scroll compressor to which the present invention is applied may include a casing 110, a drive part 120 disposed in the casing 110 and configured to generate driving power, a rotary shaft 130 configured to be rotated by the drive part 120, and a compression mechanism 140 configured to compress a refrigerant by being operated by the rotary shaft 130.

The casing 110 may include a first housing 111 configured to accommodate the drive part 120, a second housing 112 configured to accommodate an inverter 150 configured to control the drive part 120, a center head 190 configured to separate the drive part 120 and the compression mechanism 140, the compression mechanism 140 including an orbiting scroll 142 coupled to the rotary shaft 130, which penetrates the center head 190, the fixed scroll 141 configured to engage with the orbiting scroll 142 and compress a refrigerant, and a third housing 113 coupled to the fixed scroll 141 of the compression mechanism 140 and configured to define a discharge chamber F.

The first housing 111 may include an annular wall 111a, and a first partition wall 111b configured to cover one end of the annular wall 111a. The annular wall 111a, the first partition wall 111b, and the center head 190 may define a drive part accommodation space that accommodates the drive part 20.

The second housing 112 may be coupled to the first partition wall 111b and define an inverter accommodation space that accommodates the inverter 150.

The third housing 113 may be coupled to the fixed scroll 141 of the compression mechanism 140 and define the discharge chamber F.

In this case, the center head 190 separates the drive part 120 and the compression mechanism 140. A bearing hole 190a may be formed at a center of the center head 190, and a rotary shaft 30, which allows the drive part 120 and the compression mechanism 140 to operate in conjunction with each other, may penetrate the bearing hole 190a.

Meanwhile, the orbiting scroll 142 of the compression mechanism 140 may be connected, by an eccentric bushing 149, to the rotary shaft 130 that penetrates the center head 190. The third housing 113 may be fastened to the fixed scroll 141. However, the present invention is not limited thereto. The third housing 113 may be fastened to the center head 190 while accommodating the compression mechanism 140.

The drive part 120 may include a stator 121 fixed to the first housing 111, and a rotor 122 configured to be rotated in the stator 121 by an interaction with the stator 121.

The rotary shaft 130 may penetrate a central portion of the rotor 122, such that one end 130a of the rotary shaft 130 may protrude toward the first partition wall 111b based on the rotor 122, and the other end 130b of the rotary shaft 130 may protrude toward the center head 190 based on the rotor 122.

One end 130a of the rotary shaft 130 may be rotatably supported by a first bearing 171 provided at a center of the first partition wall 111b.

In this case, a first support groove 111d may be formed at the center of the first partition wall 111b, and the first bearing 171 and one end of the rotary shaft 130 may be inserted into the first support groove 111d. The first bearing 171 may be interposed between the first support groove 111d and one end 130a of the rotary shaft 130.

The other end 130b of the rotary shaft 130 may penetrate the bearing hole 190a of the center head 190 and be connected to the compression mechanism 140 by the eccentric bushing 149.

Further, the eccentric bushing 33 may be rotatably supported on a third bearing 173 provided in the compression mechanism 140. Further, the eccentric bushing 33 is connected to the third bearing 173 and transmits a rotational force to the orbiting scroll 142.

In this case, a second support groove 192 may be formed in the bearing hole 190a of the center head 190, and the second bearing 172 may be disposed in the second support groove 192. The second bearing 172 may be interposed between the second support groove 192 and the rotary shaft 130.

Further, the third bearing 173 may be interposed between the orbiting scroll 142 and the eccentric bushing 149.

The compression mechanism 140 may include the fixed scroll 141 disposed opposite to the drive part 120 based on the center head 190, and the orbiting scroll 142 configured to engage with the fixed scroll 141 and define a compression chamber C, the orbiting scroll 142 being configured to perform an orbital motion by means of the rotary shaft 130.

The fixed scroll 141 may include a fixed end plate portion 141a having a circular plate shape, and a fixed wrap 141c protruding from a compression surface 141b of the fixed end plate portion 141a and configured to engage with the orbiting scroll 142.

A discharge port 141d may be formed at a center of the fixed end plate portion 141a and formed through the fixed end plate portion 141a, and the refrigerant compressed in the compression chamber may be discharged through the discharge port 141d. In this case, the discharge port 141d may communicate with a discharge space formed between the fixed scroll 141 and the third housing 113.

The orbiting scroll 142 may include an orbiting end plate portion 142a having a circular plate shape, and an orbiting wrap 142c protruding from a compression surface 142b of the orbiting end plate portion 142a and configured to engage with the fixed scroll 141. In addition, a boss portion 142e to which the eccentric bushing 149 is coupled may be provided.

In the scroll compressor configured as described above, when power is applied to the drive part 120, the rotary shaft 130 may transmit a rotational force to the orbiting scroll 142 while rotating together with the rotor 122. Then, the orbiting scroll 142 may perform the orbital motion by means of the rotary shaft 130, and a volume of the compression chamber C may be reduced as the compression chamber C consistently moves toward the center. Then, the refrigerant may be introduced into the drive part accommodation space through a refrigerant inlet port (not illustrated) formed in the annular wall 111a of the first housing 111. Then, the refrigerant in the drive part accommodation space may be sucked into the compression chamber C through a refrigerant passing hole (not illustrated) formed in the center head 190. Then, the refrigerant sucked into the compression chamber C is compressed while flowing toward the center along a movement route of the compression chamber C, and the refrigerant may be discharged to the discharge space through the discharge port 141d. A series of processes in which the refrigerant discharged to the discharge space is discharged to the outside of the scroll compressor through a refrigerant discharge port formed in the third housing 113 is repeated.

In this process, the rotary shaft 130 is rotatably supported by the first bearing 171 and the second bearing 172, and the orbiting scroll 142 is rotatably supported on the rotary shaft 130 by the third bearing 173. The third bearing 173 may be different from the first bearing 171 and the second bearing 172 to reduce a weight and size of an assembly (hereinafter, referred to as an ‘orbital motion body’) of the third bearing 173 and the orbiting scroll 142.

Specifically, the first bearing 171 and the second bearing 172 fixed to the casing 110 may each be configured as a ball bearing to minimize a frictional loss.

In contrast, the third bearing 173, which performs the orbital motion together with the orbiting scroll 142 and is proportional to the weight and size of the orbital motion body, may be configured as a needle roller bearing or a slide bushing bearing that is smaller in weight and size and less costly than the ball bearing. Further, the third bearing 173 may be press-fitted with the boss portion 142e of the orbiting scroll by a predetermined press-fitting force.

The overall configuration of the electric compressor 100 of the present invention is as described above. Hereinafter, an elastic member 200 will be described.

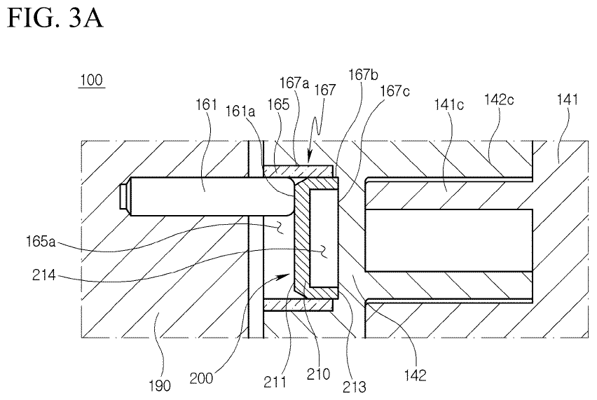

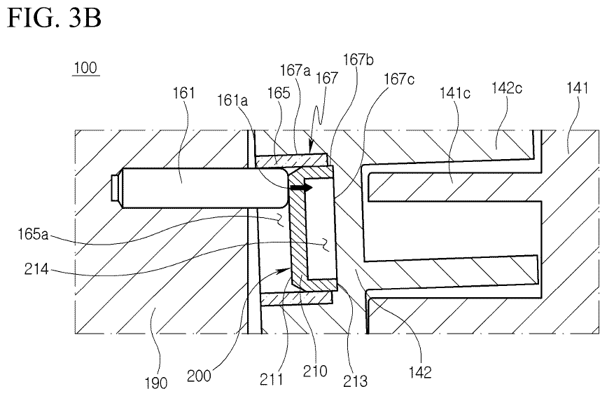

FIGS. 3A and 3B disclose a first embodiment of the elastic member 200 of the electric compressor 100 of the present invention.

With reference to FIG. 3A, the electric compressor 100 may include a guide pin 161, a guide groove 167, a sleeve ring 165, and the elastic member 200.

The guide pin 161 is coupled to the center head 190, and an end 161a of the guide pin 161 may be disposed to protrude from the center head 190 toward the orbiting scroll 142. The guide pin 161 may have a cylindrical beam shape so that the guide pin 161 smoothly moves along an inner peripheral surface of the circular ring-shaped sleeve ring 165.

The guide groove 167 may be recessed inward in a surface of the orbiting scroll 142 that faces the center head 190. The guide groove 167 may have a cylindrical groove shape.

In the embodiment of the present invention, the guide groove 167 may have a dual stepped structure and include a ring insertion groove 167a and a stepped groove 167b.

The ring insertion groove 167a may be disposed in the surface of the orbiting scroll 142 that faces the center head 190. The ring insertion groove 167a may have a circular groove shape. The sleeve ring 165 may be disposed and inserted into the ring insertion groove 167a.

The stepped groove 167b may be connected to the ring insertion groove 167a and concavely formed toward the inside of the orbiting scroll 142. The stepped groove 167b may be formed to have a step difference from the ring insertion groove 167a. Further, the elastic member 200 may be disposed and inserted into the stepped groove 167b.

The sleeve ring 165 may have a circular ring shape and be disposed on an inner periphery of the ring insertion groove 167a in an interference-fit manner. A ring hole 165a may be formed in a central portion of the sleeve ring 165, and the guide pin 161 may be inserted into the ring hole 165a.

The elastic member 200 may be disposed inside the sleeve ring 165 and simultaneously in contact with the guide groove 167 and the guide pin 161.

The elastic member 200 may be disposed and inserted into the stepped groove 167b. In this case, a periphery of the elastic member 200 may be supported by the stepped groove 167b.

In the embodiment of the present invention, a size of an outer periphery of the elastic member 200 may be equal to or larger than a size of an inner periphery of the stepped groove 167b. In case that a size of the outer periphery of the elastic member 200 is larger than a size of the inner periphery of the stepped groove 167b, the elastic member 200 may be inserted into the stepped groove 167b in a state in which the elastic member 200 is slightly pressed and contracted, and the elastic member 200 may be tightly attached to the inner surface of the stepped groove 167b as the elastic member 200 is expanded by elasticity. In this case, by an elastic force applied to the expand the elastic member 200, the elastic member 200 is securely fixed to the stepped groove 167b without being withdrawn.

Meanwhile, in the first embodiment illustrated in FIG. 3A, the elastic member 200 may be formed in a shape corresponding to the ring hole 165a. For example, the elastic member 200 may have a circular block shape and be made of a stretchable elastic material such as rubber or urethane.

The elastic member 200 may include a body portion 210, a contact portion 211, a support portion 213, and an opening portion 214.

The body portion 210 may be formed in a shape corresponding to the ring hole 165a and have a circular block shape as a whole.

The contact portion 211 may be formed on the body portion 210 that faces the guide pin 161. A surface of the contact portion 211 may be subjected to surface treatment so that the surface of the contact portion 211 is strongly resistant to abrasion. This is because abrasion may occur because when the orbiting scroll 142 orbits, the contact portion 211 orbits in a state in which the contact portion 211 is in contact with the end 161a of the guide pin 161. Therefore, the surface of the contact portion 211 may be subjected to surface treatment to reinforce abrasion resistance.

More specifically, a frictional coefficient of the contact portion 211 needs to be designed to be low, roughness of the contact portion 211 may be increased, or the contact portion 211 may be plated or coated.

In the first embodiment, the contact portion 211 may have a flat plate shape. In case that the orbiting scroll 142 is tilted or slanted, the end 161a of the guide pin 161 may come into contact with the contact portion 211, thereby mitigating the motion of the orbiting scroll 142.

In addition, when the orbiting scroll 142 rotates in the contact state, the guide pin 161 may slide without friction with the surface of the contact portion 211 subjected to the surface treatment.

In this case, the end 161a of the guide pin 161 and the contact portion 211 of the elastic member 200 may be in surface contact with each other.

The support portion 213 may be formed to protrude from a surface of the body portion 210 that faces a bottom surface 167c of the stepped groove 167b. Further, an outer surface of the support portion 213 may be fixedly inserted into an inner surface of the stepped groove 167b.

As described above, the elastic member 200 is fixed to the stepped groove 167b. Specifically, the support portion 213 of the elastic member 200 is fixedly inserted into the stepped groove 167b. Therefore, a size (e.g., diameter) of the outer periphery of the support portion 213 may be equal to or larger than a size (e.g., diameter) of the inner periphery of the stepped groove 167b. In case that a size of the outer periphery of the support portion 213 is larger than a size of the inner periphery of the stepped groove 167b, the support portion 213 may be inserted into the stepped groove 167b in a state in which the support portion 213 is pressed and contracted, and the support portion 213 may be securely fixed to the stepped groove 167b by an elastic force as the support portion 213 expands. Because the support portion 213 is securely fixed to the stepped groove 167b, the elastic member 200 is not withdrawn from the stepped groove 167b.

In the embodiment of the present invention, the support portion 213 may be disposed to protrude along a periphery of the body portion 210.

Therefore, the opening portion 214 may be formed inside the support portion 213 in the body portion 210. The opening portion 214 may provide a space in which the support portion 213 is stretched or contracted when the support portion 213 is stretched or contracted while changing in shape.

With reference to FIG. 3B, the orbiting scroll 142 may be tilted or slanted by an imbalance between initial operation back pressure and compressive force during the operation of the electric compressor 100.

In this case, the end 161a of the guide pin 161 comes into contact with the contact portion 211 of the elastic member 200, which mitigates a degree of the motion of the orbiting scroll 142 that is tilted or slanted.

In this case, the end 161a of the guide pin 161 and the contact portion 211 of the elastic member 200 are in surface contact with each other. Because the elastic member 200 is made of an elastic material, the elastic member 200 comes into surface contact with the end 161a of the guide pin 161 while being slightly deformed in shape when the elastic member 200 comes into contact with the end 161a of the guide pin 161.

That is, because the elastic member 200 and the guide pin 161 are brought into contact with each other by properties of the elastic material, it is possible to apply a more stable opposing force to restrict the motion of the orbiting scroll 142. Thereafter, a force applied by a restoring force is applied to the elastic member 200 in the direction of the arrow illustrated in FIG. 3B, which contributes to returning the orbiting scroll 142 to a normal position.

In addition, even though the orbiting scroll 142 is tilted, slanted, or warped, the orbiting scroll 142 continuously rotates because the orbiting scroll 142 is connected to the rotary shaft 130. Because the contact portion 211 of the elastic member 200 is subjected to surface treatment as described above, abrasion of the contact portion 211 of the elastic member 200 may be minimized even though the elastic member 200 rotates while maintaining the state in which the elastic member 200 is in surface contact with the end 161a of the guide pin 161.

When the orbiting scroll 142 moves back to the original position after an abnormal motion of the orbiting scroll 142 is mitigated as described above, the orbiting scroll 142 may normally rotate again, as illustrated in FIG. 3A.

That is, the contact portion 211 of the elastic member 200 and the end 161a of the guide pin 161 are not always in contact with each other. The contact portion 211 of the elastic member 200 and the end 161a of the guide pin 161 temporarily come into contact with each other when the orbiting scroll 142 abnormally operates during the operation of the compression mechanism 140, such that the abnormal motion of the orbiting scroll 142 may be mitigated, and the deterioration in performance of the electric compressor 100 may be prevented.

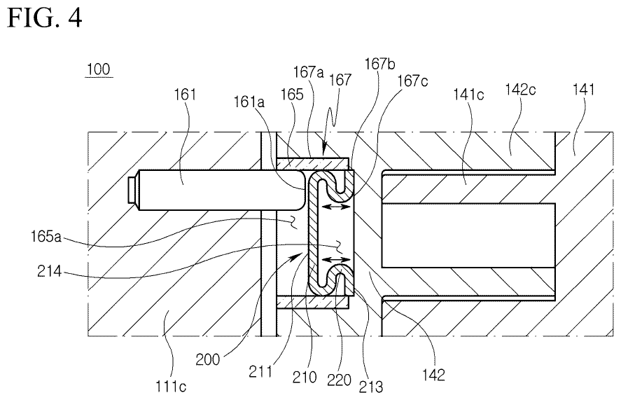

Meanwhile, FIG. 4 illustrates a second embodiment of the elastic member 200.

With reference to FIG. 4, the elastic member 200 according to the second embodiment may include the body portion 210, the contact portion 211, the support portion 213, the opening portion 214, and a stretchable/contractible portion 220.

In this case, the body portion 210, the contact portion 211, the support portion 213, and the opening portion 214 are identical to those in the first embodiment and thus are as described above. Hereinafter, the stretchable/contractible portion 220 will be described.

The stretchable/contractible portion 220 may have a bent shape disposed between the body portion 210 and the support portion 213. In this case, the stretchable/contractible portion 220 may have a shape bent at least one or more times and exhibit an elastic force like a spring.

The elastic member 200 may exhibit an elastic force in nature because the elastic member 200 is made of an elastic material such as rubber or urethane. Further, the stretchable/contractible portion 220 having a spring structure may be further provided, thereby further increasing an elastic force.

Even in this case, the opening portion 214 may provide a space in which the stretchable/contractible portion 220 may be stretched or contracted.

In case that the orbiting scroll 142 is tilted or slanted by an imbalance between initial operation back pressure and compressive force during the operation of the electric compressor 100, the elastic member 200 having the structure according to the second embodiment may mitigate the abnormal motion of the orbiting scroll 142 by means of the material properties and the stretchable/contractible portion 220, as described below.

First, in case that the orbiting scroll 142 is abnormally tilted or slanted, the end 161a of the guide pin 161 comes into contact with the contact portion 211 of the elastic member 200, thereby mitigating the motion of the orbiting scroll 142.

In this case, the end 161a of the guide pin 161 and the contact portion 211 of the elastic member 200 may come into contact with each other. Because the elastic member 200 is made of an elastic material, the elastic member 200 comes into surface contact with the end 161a of the guide pin 161 while being slightly deformed in shape when the elastic member 200 comes into contact with the end 161a of the guide pin 161.

Next, the stretchable/contractible portion 220 is slightly pressed and deformed when the end 161a of the guide pin 161 and the contact portion 211 of the elastic member 200 come into contact with each other. Thereafter, the contact portion 211 of the elastic member 200 may maintain the surface contact state by applying the force applied by the elastic force toward the end 161a of the guide pin 161. In addition, the force applied by the elastic force is applied to the support portion 213 toward the bottom surface 167c of the stepped groove 167b, thereby applying the force that returns the orbiting scroll 142 to the normal position.

That is, the stretchable/contractible portion 220 applies the force applied by the elastic force toward two opposite sides as shown by the arrow, thereby contributing to maintaining the surface contact state and restoring the orbiting scroll 142 to the normal position.

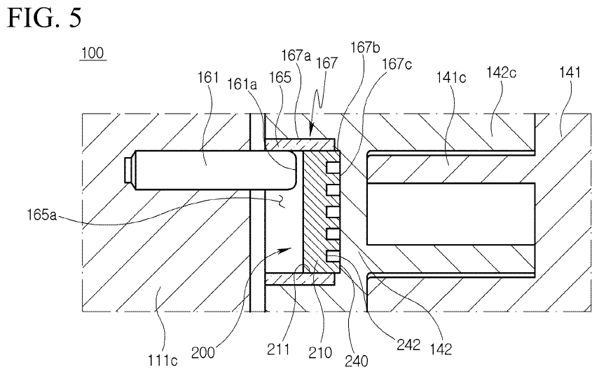

Meanwhile, FIG. 5 illustrates a third embodiment of the elastic member 200.

With reference to FIG. 5, the elastic member 200 according to the third embodiment may include the body portion 210, a contact portion 230, protrusion portions 240, and open grooves 242.

The body portion 210 may be formed in a shape corresponding to the ring hole 165a and have a circular block shape as a whole.

The contact portion 211 may be formed on the body portion 210 that faces the guide pin 161. A surface of the contact portion 211 may be subjected to surface treatment so that the surface of the contact portion 211 is strongly resistant to abrasion. This is because abrasion may occur because when the orbiting scroll 142 orbits, the contact portion 211 orbits in a state in which the contact portion 211 is in contact with the end 161a of the guide pin 161. Therefore, the surface of the contact portion 211 may be subjected to surface treatment to reinforce abrasion resistance. The function of the contact portion 211 may be identical to that in the first embodiment.

The protrusion portion 240 may be formed to protrude from the surface of the body portion 210 that faces the bottom surface 167c of the stepped groove 167b. The protrusion portions 240 may be provided as a plurality of protrusion portions 240.

The open grooves 242 may be concavely formed between the plurality of protrusion portions 240 in the body portion 210. The open groove 242 provides a space in which the protrusion portion 240 may be deformed when the protrusion portion 240 is deformed while being stretched or contracted.

In case that the orbiting scroll 142 is tilted or slanted by an imbalance between initial operation back pressure and compressive force during the operation of the electric compressor 100, the end 161a of the guide pin 161 comes into contact with the contact portion 211 of the elastic member 200 having the structure according to the third embodiment, thereby mitigating the motion of the orbiting scroll 142.

In this case, the end 161a of the guide pin 161 and the contact portion 211 of the elastic member 200 may come into contact with each other. Because the elastic member 200 is made of an elastic material, the contact portion 211 comes into surface contact with the end 161a of the guide pin 161 while being slightly deformed in shape when the contact portion 211 comes into contact with the end 161a of the guide pin 161.

Further, the plurality of protrusion portions 240 are spaced apart from one another on the body portion 210 and being in contact with the bottom surface 167c of the stepped groove 167b. Therefore, a degree to which the contact portion 211 is pressed is restricted even though a portion where the end 161a of the guide pin 161 comes into contact with the contact portion 211 is changed as the orbiting scroll 142 orbits.

In case that the end 161a of the guide pin 161 comes into contact with the central portion of the contact portion 211, the contact portion 211 of the elastic member 200 illustrated in FIG. 3A may be deformed while being relatively greatly pressed. This is because the opening portion 214 is formed at a side of the body portion 210 opposite to the contact portion 211.

In contrast, because the plurality of protrusion portions 240 of the elastic member 200 illustrated in FIG. 5A are disposed at predetermined intervals, a degree to which the contact portion 211 is pressed and deformed may be comparatively constantly maintained even though the position of the contact portion 211, which comes into contact with the end 161a of the guide pin 161, is changed. In addition, because the open grooves 242 are formed between the plurality of protrusion portions 240, thereby ensuring the space in which the plurality of protrusion portions 240 are deformed while being slightly pressed.

This structure brings the contact portion 211 into stable surface contact with the end 161a of the guide pin 161. The force applied to press the contact portion 211 by the guide pin 161 is constantly transmitted to the protrusion portions 240 disposed at the corresponding positions among the plurality of protrusion portions 240 regardless of the position of the contact portion 211.

Thereafter, the protrusion portion 240 at the corresponding position applies the force applied by the elastic force toward the bottom surface 167c of the stepped groove 167b, thereby contributing to applying the force that returns the orbiting scroll 142 to the normal position.

According to the above-mentioned embodiments of the present invention, it is possible to mitigate a degree to which the orbiting scroll is tilted, slanted, or warped during the operation. In addition, the orbiting scroll and the fixed scroll may properly engage with each other, which may prevent a deterioration in compression performance. Further, it is possible to reduce the occurrence of noise by mitigating impact between the wrap of the orbiting scroll and the wrap of the fixed scroll, thereby improving the performance of the electric compressor.

The foregoing description is provided only for explaining the specific embodiments of the electric compressor.

Accordingly, it is noted that those skilled in the art can easily ascertain that the present invention may be substituted or modified in various forms without departing from the scope of the present invention defined in the appended claims.

The present invention relates to the electric compressor and is industrially available.

1-11. (canceled)

12. An electric compressor comprising:
a casing;
a drive part disposed in the casing and configured to generate power;
a compression mechanism further comprising an orbiting scroll, and a fixed scroll configured to engage with the orbiting scroll and compress a refrigerant;
a rotary shaft configured to rotate to receive power from the drive part and transmit the power to the compression mechanism;
a center head disposed between the drive part and the compression mechanism and configured to support the rotary shaft;
a guide pin disposed on a surface of the center head that faces the orbiting scroll, the guide pin having an end protruding toward the orbiting scroll;
a guide groove recessed inward in a surface of the orbiting scroll that faces the center head;
a sleeve ring disposed at an inner periphery of the guide groove and having an open ring hole into which an end of the guide pin is inserted; and
an elastic member disposed in the sleeve ring and configured to simultaneously come into contact with the end of the guide pin and the guide groove.

13. The electric compressor of claim 12, wherein the guide groove has a dual stepped structure, and wherein the guide groove further comprises:
a ring insertion groove disposed in a surface of the orbiting scroll facing the center head so the sleeve ring is inserted into the ring insertion groove; and
a stepped groove connected to the ring insertion groove and configured to define a step difference together with the ring insertion groove, the elastic member disposed in the stepped groove.

14. The electric compressor of claim 13, wherein a periphery of the elastic member is supported by the stepped groove.

15. The electric compressor of claim 14, wherein a size of an outer periphery of the elastic member is equal to or larger than a size of an inner periphery of the stepped groove.

16. The electric compressor of claim 15, wherein the elastic member is inserted into the stepped groove and then expands without being withdrawn from the stepped groove.

17. The electric compressor of claim 13, wherein the elastic member is temporarily in contact with, instead of being always in contact with, the end of the guide pin and a bottom surface of the stepped groove during an operation of the compression mechanism.

18. The electric compressor of claim 13, wherein the contact between the end of the guide pin and the elastic member is surface contact.

19. The electric compressor of claim 13, wherein the elastic member further comprises:
a body portion formed in a shape corresponding to the ring hole;
a contact portion formed on a first surface of the body portion that faces the guide pin;
a support portion formed to protruding from a second surface of the body portion that faces a bottom surface of the stepped groove; and
an opening portion formed inside the support portion in the body portion.

20. The electric compressor of claim 19, wherein the contact portion has a flat plate shape.

21. The electric compressor of claim 19, wherein the elastic member further comprises a stretchable/contractible portion having a bent shape disposed between the body portion and the support portion.

22. The electric compressor of claim 19, wherein the elastic member further comprises:
a plurality of protrusion portions formed to protrude from the surface of the body portion that faces the bottom surface of the stepped groove; and
a plurality of open grooves concavely formed between the plurality of protrusion portions in the body portion.
